(19) United States
(12) Patent Application Publication
(10) Pub. No.: US 2009/0218341 A1
(43) Pub. Date: Sep. 3, 2009

(54) Holding device for garbage bag

(76) Inventor: Wen Cheng Wu, Taichung (TW)

Correspondence Address: CHARLES E. BAXLEY, ESQUIRE, 90 JOHN STREET, SUITE 309, NEW YORK, NY, 10038, US

(21) Appl. No.: 12/150,468

(22) Filed: Apr. 28, 2008

(30) Foreign Application Priority Data
Mar. 3, 2008 (TW) 097203543

(51) Int. Cl. B65F 1/06; B65F 1/00; B65F 1/16; B65D 25/16

(52) U.S. Cl. 220/4.28

(57) ABSTRACT

A holding device includes a receptacle having a base and an upper frame each of which includes four side grooves and four socket openings and four anchor members, four posts secured between the base and the upper frame with latch devices, and four boards engaged between the base and the upper frame and the posts, the upper frame and the posts and the boards may be disassembled from the base for allowing holding device to be disassembled to a compact folding structure that is excellent for the storing and the transportation purposes. The posts each may include a backup panel and two beams secured together that may also be disassembled from each other.

### BACKGROUND OF THE INVENTION

1. Field of the Invention

The present invention relates to a holding device for supporting a replaceable garbage bag, and more particularly to a holding device including a foldable structure that may be disassembled or folded to a compact folding structure for facilitating the storing and transportation purposes.

2. Description of the Prior Art

Typical holding devices for supporting replaceable bags or garbage bags normally comprise a housing receptacle having a hollow interior for receiving and supporting a replaceable bag or a garbage bag.

For example, U.S. Pat. No. 3,836,037 to Bass, U.S. Pat. No. 3,922,046 to Schneider, U.S. Pat. No. 4,062,604 to Popper, and U.S. Pat. No. 4,798,363 to Cortesi disclose four of the typical holding devices for supporting replaceable bags or garbage bags each also comprising a box-shaped cabinet or a housing receptacle having a hollow interior for receiving a replaceable bag or a garbage bag and for supporting the replaceable bag or garbage bag with an attaching or supporting mechanism.

However, the box-shaped cabinet or housing receptacle includes a great volume that may not be disassembled or folded to a compact folding structure such that the typical holding devices for supporting replaceable bags or garbage bags are not good storing and transportation purposes.

U.S. Pat. No. 5,322,179 to Ting discloses another typical holding device for supporting replaceable bags or garbage bags comprising an inner can removably disposed within an outer can for receiving a replaceable bag or a garbage bag and for supporting the replaceable bag or garbage bag with an automatic attaching or holding mechanism.

However, the inner can and the outer can both include a great volume that may not be disassembled or folded to a compact folding structure such that the typical holding devices for supporting replaceable bags or garbage bags are not good storing and transportation purposes.

The present invention has arisen to mitigate and/or obviate the afore-described disadvantages of the conventional holding devices for supporting replaceable bags or garbage bags.

### SUMMARY OF THE INVENTION

The primary objective of the present invention is to provide a holding device including a foldable structure that may be disassembled or folded to a compact folding structure for facilitating the storing and transportation purposes.

In accordance with one aspect of the invention, there is provided a holding device comprising a receptacle including a base having a groove formed in each of four side portions of the base, and having four socket openings formed in each of four corner areas of the base, and having four anchor members extended upwardly from the corner areas of the base, an upper frame including a groove formed in each of four side portions of the upper frame, and including four socket openings formed in each of four corner areas of the upper frame, and including four anchor members extended downwardly from the corner areas of the upper frame, and the upper frame being provided for engaging with and for attaching a garbage bag, four posts each including a lower end for engaging into the socket openings of the base respectively, and each including an upper end for engaging into the socket openings of the upper frame respectively, and each including two side slots formed in each of the posts, two latch devices attached to the lower end and the upper end of each of the posts for engaging with the anchor members of the base and the upper frame respectively, and for latching and securing the posts between the base and the upper frame, and four boards each including a lower portion for engaging into the grooves of the base respectively, and each including two side portions for engaging into the side slots of the posts respectively, and each including an upper portion for engaging into the grooves of the upper frame respectively and for allowing the boards to be secured and retained between the base and the posts and the upper frame.

The posts each include a backup panel and two beams secured together. The posts each include two extensions provided on the lower end and the upper end of the posts respectively for attaching the latch devices.

The extensions are secured to the panels of the posts respectively. The posts each include two passages formed in the beams for receiving the extensions.

The latch devices each include a handle pivotally coupled to the posts with a pivot axle, and a catch pivotally coupled to the handle with a pivot shaft which is separated from the pivot axle for allowing the catch to be moved up and down relative to the post with the handle and for allowing the catch to be caused to engage with the anchor members of the base respectively.

The base includes at least one anchor opening formed in each of the anchor members of the base, and the latch devices each include at least one tongue for engaging with the anchor opening of the anchor members of the base and for latching the posts to the base.

The upper frame includes at least one hook extended from the upper frame for engaging with and for attaching the garbage bag. The upper frame includes a peripheral fence extended upwardly therefrom for engaging with and for attaching a cover.

An inner casing may further be provided and disposed in the receptacle for supporting the garbage bag. The inner casing includes two casing members detachably secured and coupled together with at least one catch.

The catch is extended from a first casing member of the casing members, and a second casing member of the casing members includes at least one latch opening formed therein for engaging with the catch and for securing and coupling the casing members together.

The inner casing includes a hand grip attached to one of the casing members. The base includes a hollow chamber formed in a bottom portion and a number of ribs provided in the base for reinforcing the base.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a holding device for supporting a replaceable garbage bag in accordance with the present invention;

FIG. 2 is a perspective view similar to FIG. 1 illustrating the application of the holding device;

FIG. 3 is an exploded view of the holding device;

FIG. 4 is a bottom perspective view illustrating an upper frame for the holding device;

FIG. 5 is another exploded view of the holding device;

FIG. 6 is a cross sectional view of the holding device taken along lines 6-6 of FIG. 1;

FIGS. 7, 8 are cross sectional views of the holding device taken along lines 7-7, and 8-8 of FIG. 6 respectively;

FIG. 9 is a partial exploded view illustrating the assembling operation of the holding device;

FIGS. 10, 11 are partial perspective illustrating the assembling operation of the holding device;

FIG. 12 is a further exploded view illustrating an inner casing of the holding device; and

FIG. 13 is a still further partial exploded view illustrating the securing or latching device for the inner casing of the holding device.

### DETAILED DESCRIPTION OF THE PREFERRED EMBODIMENT

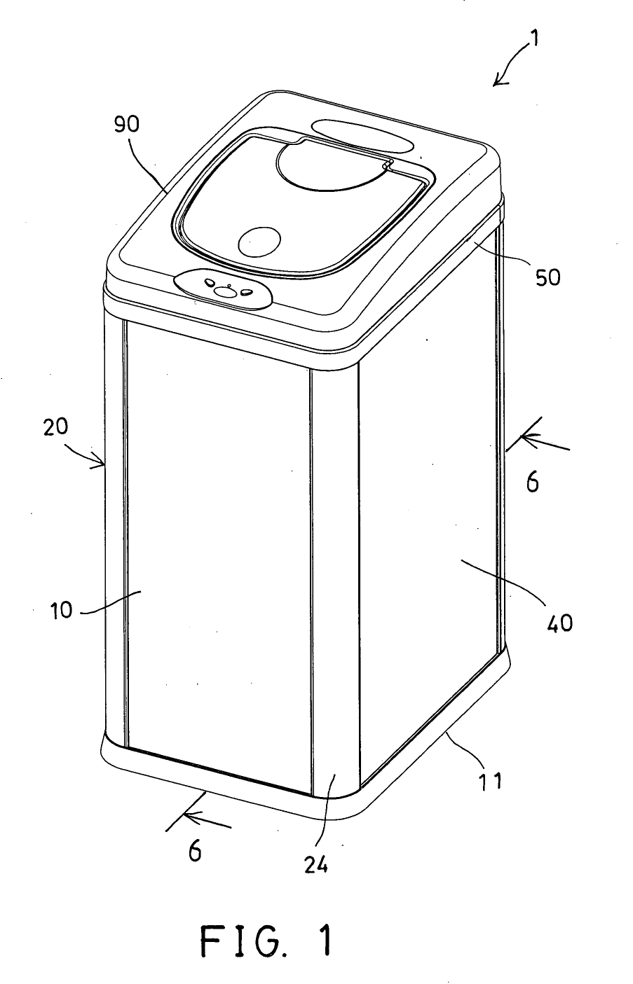

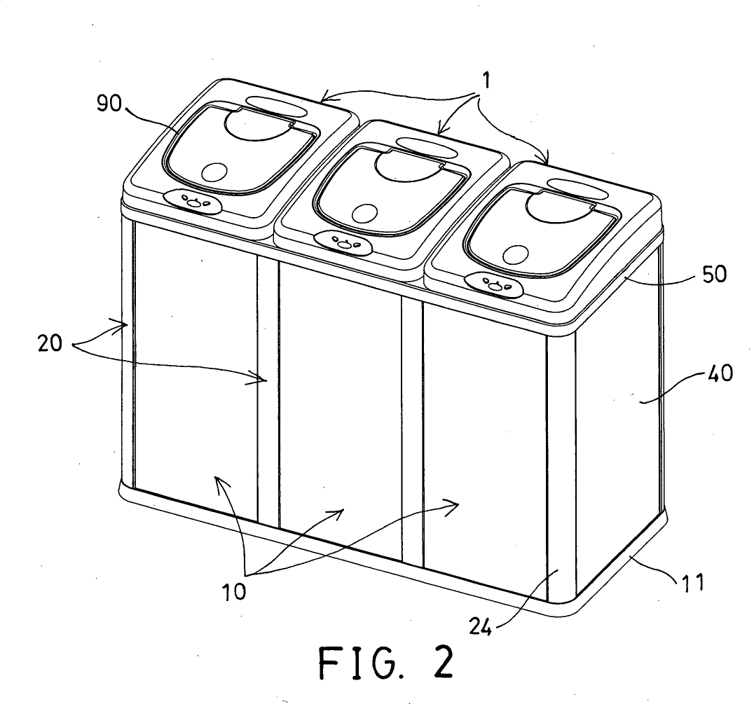

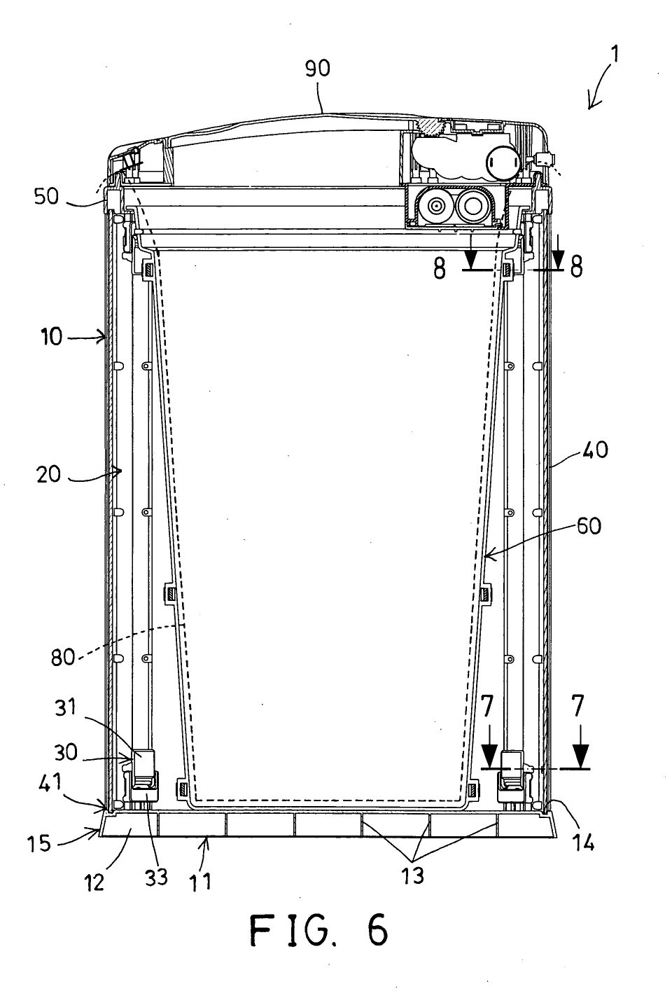

Referring to the drawings, and initially to FIGS. 1-3 and 6, a holding device 1 in accordance with the present invention comprises an outer receptacle 10, an inner casing 60 removably disposed within the outer receptacle 10 for supporting a replaceable garbage bag 80 (FIG. 6), and a cover 90 attached or disposed on top of the outer receptacle 10 for covering or closing the outer receptacle 10 and the inner casing 60, and for protecting or shielding the inner casing 60 and the replaceable garbage bag 80, best shown in FIG. 6. As shown in FIG. 2, two or more holding devices 1 in accordance with the present invention may be disposed side by side or disposed together for collecting garbage refuse, trash, cans, bottles (not shown), or other objects that may be recycled.

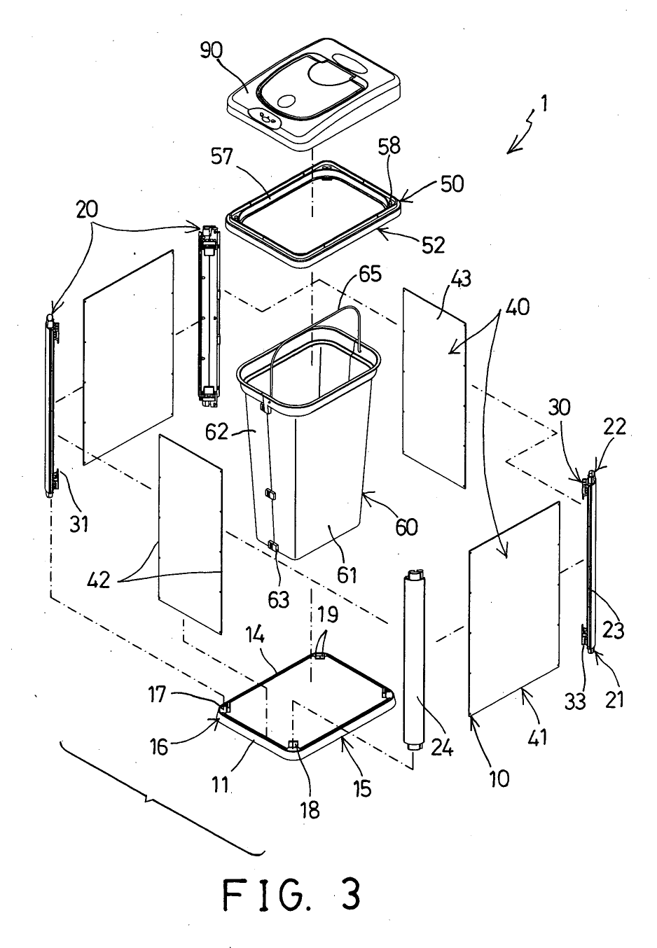

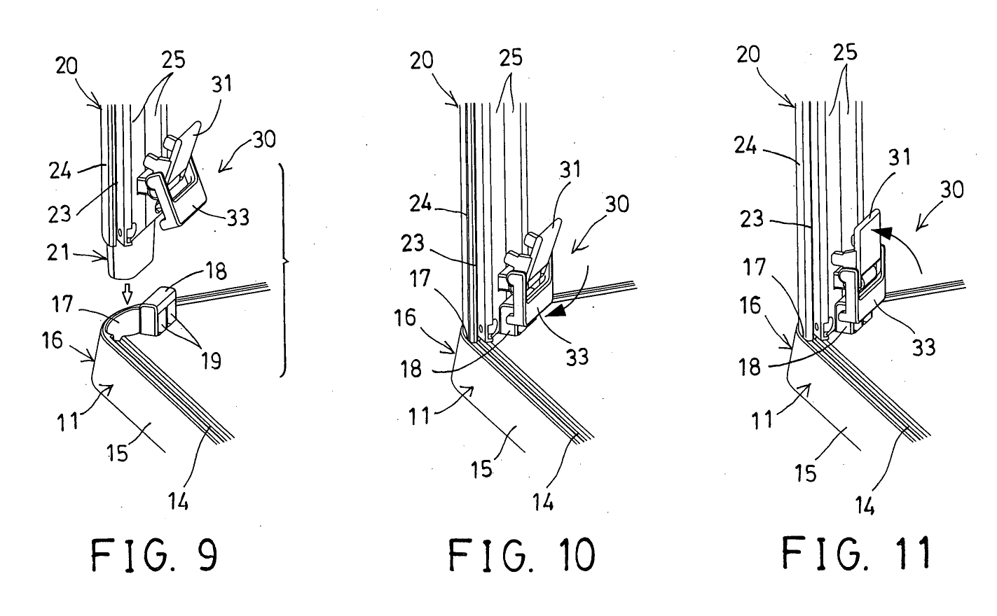

The receptacle 10 includes a base 11 having a hollow chamber 12 formed in the bottom portion thereof (FIG. 6) and having a number of ribs 13 provided therein for reinforcing purposes, the base 11 includes a substantially square or rectangular or parallelogrammic structure having a groove 14 formed in each of the four side portions 15 thereof (FIGS. 3, 6, and 9-11), and includes four corner areas 16 each having a socket opening 17 formed therein, and includes an anchor member 18 provided or extended upwardly from each of the four corner areas 16 and arranged or located beside the socket opening 17 respectively best shown in FIGS. 9-11, and the anchor members 18 each include one or more (such as two) anchor openings 19 formed therein (FIGS. 3, and 9).

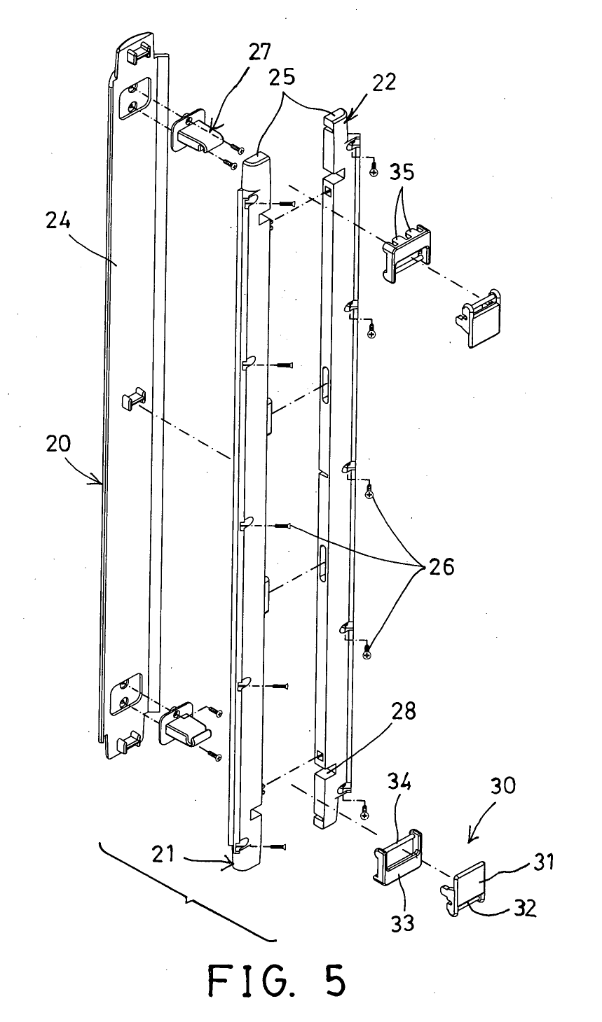

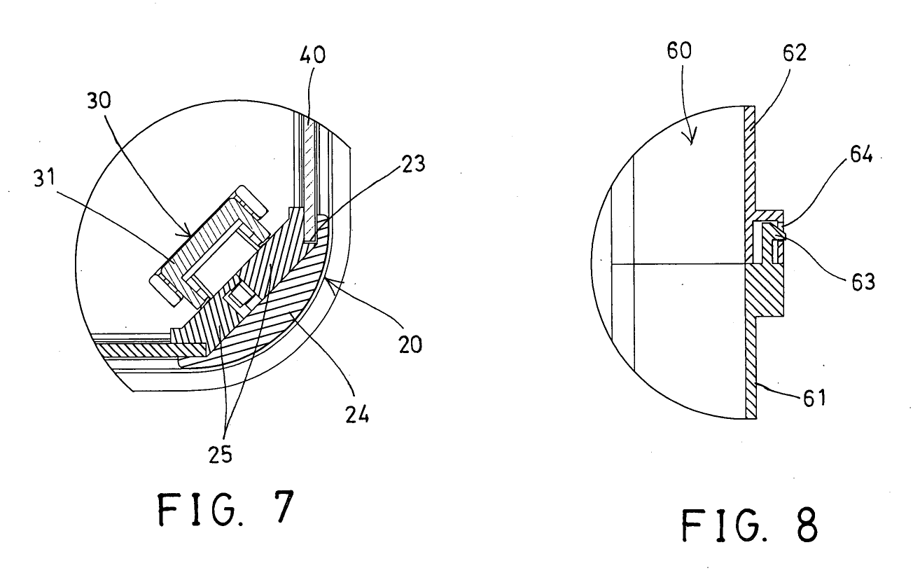

Four posts 20 each include a lower end 21 for engaging into the socket opening 17 of the base 11 respectively, and each include an upper end 22, and each include two side slots 23 formed therein (FIGS. 3, 7, and 9-11). As shown in FIG. 5, The posts 20 each may include a backup panel 24 and two beams 25 secured together with such as fasteners 26, one or more (such as two) studs or extensions 27 secured to the panel 24, and one or more (such as two) passages 28 formed in the beams 25 for receiving the extensions 27 and for allowing the extensions 27 to be extended outwardly through the passages 28 of the beams 25. One or more (such as two) hook or latch devices 30 are attached to each of the posts 20, such as attached to the lower end 21 and the upper end 22 of the post 20 and/or coupled to the extensions 27 respectively.

The quick-release latch devices 30 each include a handle 31 rotatably or pivotally coupled to the extension 27 of the posts 20 with a pivot axle 32 respectively, and a catch 33 rotatably or pivotally coupled to the handle 31 with a pivot shaft 34 which is separated from or offset from the pivot axle 32 for allowing the catch 33 to be moved up and down relative to the post 20 with the handle 31, and the catches 33 each include one or more (such as two) tongues 35 provided thereon or extended therefrom (FIG. 5) for engaging with the anchor openings 19 of the anchor members 18 of the base 11 respectively (FIGS. 9-11), and for easily and readily and quickly hooking and latching or securing the posts 20 to the base 11 and thus for allowing the posts 20 to be secured the base 11 and to be detached from the base 11 when required.

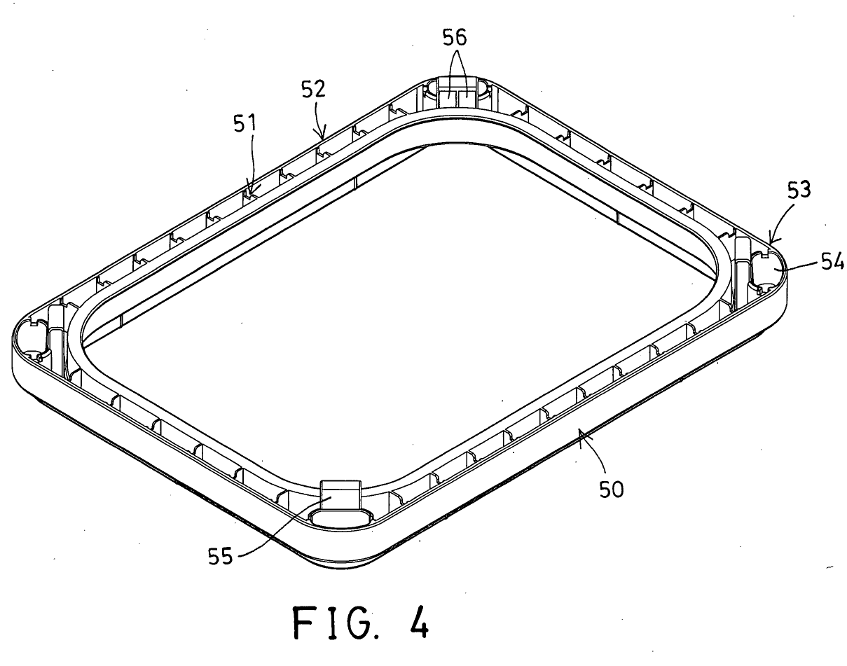

The receptacle 10 further includes four outer boards 40 each having a lower portion 41 (FIGS. 3, and 6) for engaging into the grooves 14 of the base 11 respectively, and each having two side portions 42 for engaging into the side slots 23 of the posts 20 respectively, and each having an upper portion 43 for engaging with an upper frame 50 (FIGS. 3, 4 and 6) and for allowing the outer boards 40 to be stably and solidly secured and retained between the base 11 and the posts 20 and the upper frame 50. As shown in FIG. 4, the upper frame 50 also includes a substantially square or rectangular or parallelogrammic structure having a groove 51 formed in each of the four side portions 52 thereof for engaging with the upper portions 43 of the outer boards 40 and for anchoring the outer boards 40 between the base 11 and the posts 20 and the upper frame 50.

The upper frame 50 also includes four corner areas 53 each having a socket opening 54 formed therein for receiving the upper ends 22 of the posts 20 respectively, and includes an anchor member 55 provided or extended downwardly from each of the four corner areas 53 and arranged or located beside the socket opening 54 respectively, and the anchor members 55 each also include one or more (such as two) anchor openings 56 formed therein (FIG. 4) for receiving or engaging with the tongues 35 of the catches 33 of the latch devices 30 and for solidly securing the outer boards 40 between the base 11 and the posts 20 and the upper frame 50. The upper frame 50 further includes a peripheral fence 57 extended upwardly therefrom for engaging with or for attaching the cover 90, and includes four hooks 58 extended upwardly from the corner areas 53 for engaging with or for detachably attaching the replaceable garbage bag 80.

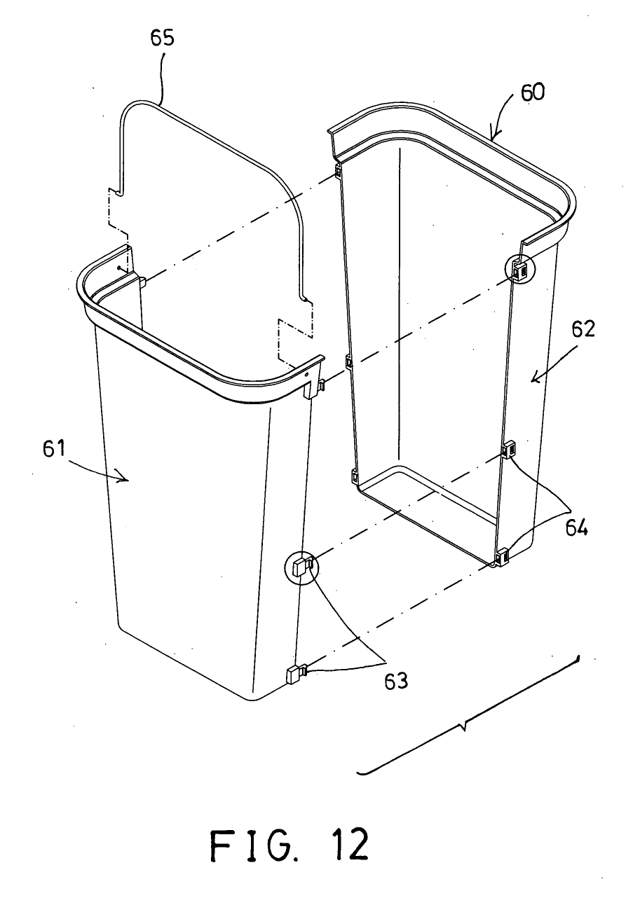

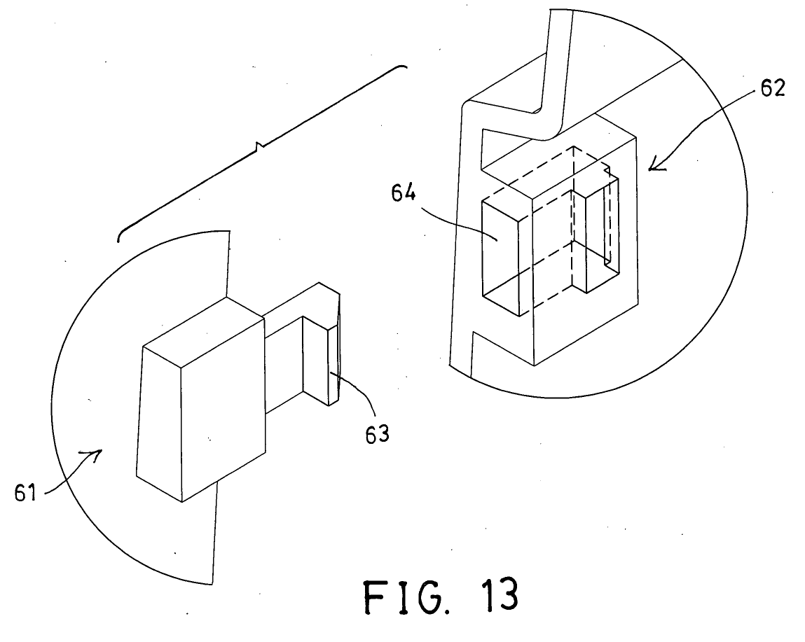

The inner casing 60 includes two casing members 61, 62 to be detachably attached or secured or coupled together with fasteners or catches 63 (FIGS. 8, 12, 13). For example, the catches 63 may be provided or extended from one of the casing members 61, and the other casing member 62 may include one or more latch openings 64 for engaging with the catches 63 and for detachably attaching or securing or coupling the casing members 61, 62 together. The inner casing 60 further includes a hand grip 65 attached or secured or coupled to one of the casing members 61 for carrying the inner casing 60 and for allowing the inner casing 60 to be easily carried with the user and to be easily moved to any required place or position.

In operation, as shown in FIGS. 3, 6, and 9-11, the lower ends 21 of the posts 20 may first be engaged into the socket opening 17 of the base 11 respectively, and the tongues 35 of the catches 33 of the latch devices 30 may then be hooked or engaged with the anchor openings 19 of the anchor members 18 of the base 11 respectively for easily and quickly securing the posts 20 to the base 11. The outer boards 40 may then be engaged through the side slots 23 of the posts 20 and may have the lower portions 41 engaged with the grooves 14 of the base 11 respectively, and the upper frame 50 may then be engaged onto or on top of the posts 20 and the outer boards 40 for forming a detachable and solid structure for the receptacle 10. The cover 90 may be simply disposed on top of the upper frame 50, or alternatively, may be rotatably or pivotally coupled to the upper frame 50.

It is to be noted that the cover 90 and the upper frame 50 and the posts 20 and the outer boards 40 may be disassembled or detached from the base 11, and the casing members 61 of the inner casing 60 may also be disassembled or detached from each other, and the backup panels 24 and the beams 25 of the posts 20 may also be disassembled or detached from each other such that the holding device 1 in accordance with the present invention may be disassembled or folded to a compact folding structure that is excellent for the storing and the transportation purposes. The inner casing 60 may be optionally provided and disposed within the outer receptacle 10 for supporting the replaceable garbage bag 80.

Accordingly, the holding device in accordance with the present invention includes a foldable structure that may be disassembled or folded to a compact folding structure for facilitating the storing and transportation purposes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A holding device comprising:
a receptacle including a base having a groove formed in each of four side portions of said base, and having four socket openings formed in each of four corner areas of said base, and having four anchor members extended upwardly from said corner areas of said base,
an upper frame including a groove formed in each of four side portions of said upper frame, and including four socket openings formed in each of four corner areas of said upper frame, and including four anchor members extended downwardly from said corner areas of said upper frame, and said upper frame being provided for engaging with and for attaching a garbage bag,
four posts each including a lower end for engaging into said socket openings of said base respectively, and each including an upper end for engaging into said socket openings of said upper frame respectively, and each including two side slots formed in each of said posts,
two latch devices attached to said lower end and said upper end of each of said posts for engaging with said anchor members of said base and said upper frame respectively, and for latching and securing said posts between said base and said upper frame, and
four boards each including a lower portion for engaging into said grooves of said base respectively, and each including two side portions for engaging into said side slots of said posts respectively, and each including an upper portion for engaging into said grooves of said upper frame respectively and for allowing said boards to be secured and retained between said base and said posts and said upper frame.

2. The holding device as claimed in claim 1, wherein said posts each include a backup panel and two beams secured together.

3. The holding device as claimed in claim 2, wherein said posts each include two extensions provided on said lower end and said upper end of said posts respectively for attaching said latch devices.

4. The holding device as claimed in claim 3, wherein said extensions are secured to said panels of said posts respectively.

5. The holding device as claimed in claim 3, wherein said posts each include two passages formed in said beams for receiving said extensions.

6. The holding device as claimed in claim 1, wherein said latch devices each include a handle pivotally coupled to said posts with a pivot axle, and a catch pivotally coupled to said handle with a pivot shaft which is separated from said pivot axle for allowing said catch to be moved up and down relative to said post with said handle and for allowing said catch to be caused to engage with said anchor members of said base respectively.

7. The holding device as claimed in claim 6, wherein said base includes at least one anchor opening formed in each of said anchor members of said base, and said latch devices each include at least one tongue for engaging with said at least one anchor opening of said anchor members of said base and for latching said posts to said base.

8. The holding device as claimed in claim 1, wherein said upper frame includes at least one hook extended from said upper frame for engaging with and for attaching said garbage bag.

9. The holding device as claimed in claim 1, wherein said upper frame includes a peripheral fence extended upwardly therefrom for engaging with and for attaching a cover.

10. The holding device as claimed in claim 1 further comprising an inner casing disposed in said receptacle for supporting said garbage bag.

11. The holding device as claimed in claim 10, wherein said inner casing includes two casing members detachably secured and coupled together with at least one catch.

12. The holding device as claimed in claim 11, wherein said at least one catch is extended from a first casing member of said casing members, and a second casing member of said casing members includes at least one latch opening formed therein for engaging with said at least one catch and for securing and coupling said casing members together.

13. The holding device as claimed in claim 11, wherein said inner casing includes a hand grip attached to one of said casing members.

14. The holding device as claimed in claim 1, wherein said base includes a hollow chamber formed in a bottom portion and a plurality of ribs provided in said base for reinforcing said base.
